(19) United States
(12) Patent Application Publication
(10) Pub. No.: US 2008/0056413 A1
(43) Pub. Date: Mar. 6, 2008

(54) ADAPTIVE AGC APPROACH TO MAXIMIZE RECEIVED SIGNAL FIDELITY AND MINIMIZE RECEIVER POWER DISSIPATION

(75) Inventors: Alpaslan Demir, East Meadow, NY (US); Kenneth P. Kearney, Smithtown, NY (US); Leonid Kazakevich, Plainview, NY (US); Tanbir Haque, Jackson Heights, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/846,816

(22) Filed: Aug. 29, 2007

Related U.S. Application Data
(60) Provisional application No. 60/840,816, filed on Aug. 29, 2006.

(51) Int. Cl. H04L 27/08

(52) U.S. Cl. 375/345

(57) ABSTRACT

A wireless transmit receive unit (WTRU) includes a receiver and an automatic gain circuit (AGC). The AGC is configured to acquire a desired signal strength, acquire an interferer strength, and set a gain of the receiver based upon the desired signal strength and the interferer strength.

### CROSS REFERENCE TO RELATED APPLICATION

This application claims the benefit of U.S. Provisional Application No. 60/840,816 filed Aug. 29, 2006, which is incorporated herein by reference as if fully set forth.

### FIELD OF INVENTION

The present invention is related to a receiver in a wireless communication system. More particularly, an adaptive automatic gain control (AGC) that may be adjusted to maximize signal fidelity and minimize power consumption is disclosed.

### BACKGROUND

Wireless transmit receive units (WTRUs) typically use AGCs to prevent saturation of analog-to-digital converters (ADCs) typically used in the receiver circuitry. FIG. 1 is a block diagram of a typical AGC 100 in accordance with the prior art. An AGC 100 uses a wideband received signal strength indicator (WRSSI) signal that includes the combined power of the desired signal I(t), Q(t) and the interferer as measured at the input of root raised cosine (RRC) filter 112. The AGC 100 includes a low noise amplifier (LNA) 102 that receives the complete analog signal, amplifies the signal, and outputs the signal to a mixer 104. The mixer 104 splits the signal into its I(t) and Q(t) components. I(t) and Q(t) are input into low pass filters (LPFs) 106 that remove any high frequency contents. Each signal is then input into a variable gain amplifier (VGA) 108 and processed at an ADC 110. The processed signals are tapped and recombined in a root-mean-square (rms) operator 114. The recombined signal is compared to reference signal P_{ref} 116 at comparator 118. A difference between P_{REF} (WRSSI) 116 and the recombined signal is converted back to analog at digita-to-analog converter (DAC) 120 and used as a bias for both LNA 102 and VGA 108.

FIG. 2 is a schematic diagram of a typical received signal strength indicator (RSSI) based AGC 200 in accordance with the prior art. AGC 200 operates in substantially the same manner as the AGC 100 of FIG. 1 with the exception that the signal is tapped after RRC filtering. The RRC filtering removes the interferer. Therefore signal power alone is measured at the output of RRC filters 212. This measure is the RSSI. The RSSI is then compared to a reference power level P_{REF} (RSSI) 214 and the error is used to bias LNA 202 and VGA 208.

Both types of AGCs 100 and AGC 200, shown in FIGS. 1 and 2 respectively, have limitations and disadvantages. FIG. 3 is a graph of P_{REF} (WRSSI) 116 for AGC 100 and P_{REF} (RSSI) 214 for AGC 200. For the graph of FIG. 3, it is assumed that ADCs 110 and 210 provide 12 bits (72 dB) of resolution and that the difference in power between the interferer and the desired signal is 30 dB after analog filtering. While there may be multiple interferers in the adjacent and subsequent alternate channels, only the adjacent channel interferer is shown.

The difference in power between the adjacent channel interferer and the desired signal may be as high as 45 dB. A maximum of 15 dB of analog adjacent channel filtering may typically be available in current art receivers.

For AGC 100, P_{REF} (WRSSI) 116 is set such that the combined rms level of the signal and interferer is located below ADC 110 full scale input level by an amount equal to the signal and interferer combined waveform peak to average ratio (PAR). This is shown as 12 dB in FIG. 3.

The worst case difference between the interferer and the desired signal level after analog filtering is considered in determining the number of bits required for the ADC. This difference is shown as 30 dB in FIG. 3. Also typical of current art receivers is that at least 5 bits, equivalent to 30 dB, of signal resolution is required for proper demodulation. The result is 12 bits of resolution required from the ADC. As no knowledge of the signal level is available to AGC 100, it is not possible to minimize the receiver power consumption based on the input signal level.

For AGC 200, P_{REF} (RSSI) 216 is set such that the rms level of the signal is located 42 dB below ADC 210 full scale input level as shown in FIG. 3. The 42 dB overhead in this case is left to accommodate the filtered interferer and the combined waveform peak to average ratio at the input of the ADC. Again, it may be assumed that at least 5 bits of signal resolution is required for demodulation. The result once again is 12 bits of resolution required from ADC 210 as shown in FIG. 3. AGC 200 does not require knowledge of the interferer level to operate. Enough overhead is provided to accommodate the worst case interferer level after filtering. Since no knowledge of the interferer level is available to AGC 200, it is not possible to optimize receiver gain and therefore signal fidelity, based on the interferer level.

It would be desirable for an AGC to have knowledge of the instantaneous interferer level, so that receiver gain could be increased during time periods when the interferer is not at maximum strength, thereby providing additional signal fidelity during those periods. Conversely, if it is known that a particular AGC will have knowledge of both the interferer and the signal levels, a receiver may be designed with an ADC with comparatively lower resolution.

During periods of maximum interferer strength, the signal fidelity may suffer. However, it may be assumed that the interferer attains maximum strength only occasionally and the loss of signal fidelity during those times would not disrupt the communications link significantly. An AGC that used both WRSSI and RSSI may provide for a receiver to be designed with a comparatively lower resolution ADC.

### SUMMARY

Disclosed is a method and apparatus for an AGC in a WTRU. The AGC may be configured to acquire a desired signal strength, acquire an interferer strength, and set a gain of the receiver based upon the desired signal strength and the interferer strength. The AGC may utilize knowledge of both a desired signal strength and an interferer strength to maximize the received signal fidelity or minimize the receiver power consumption.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 is a schematic diagram of a WRSSI-based AGC as in the prior art;

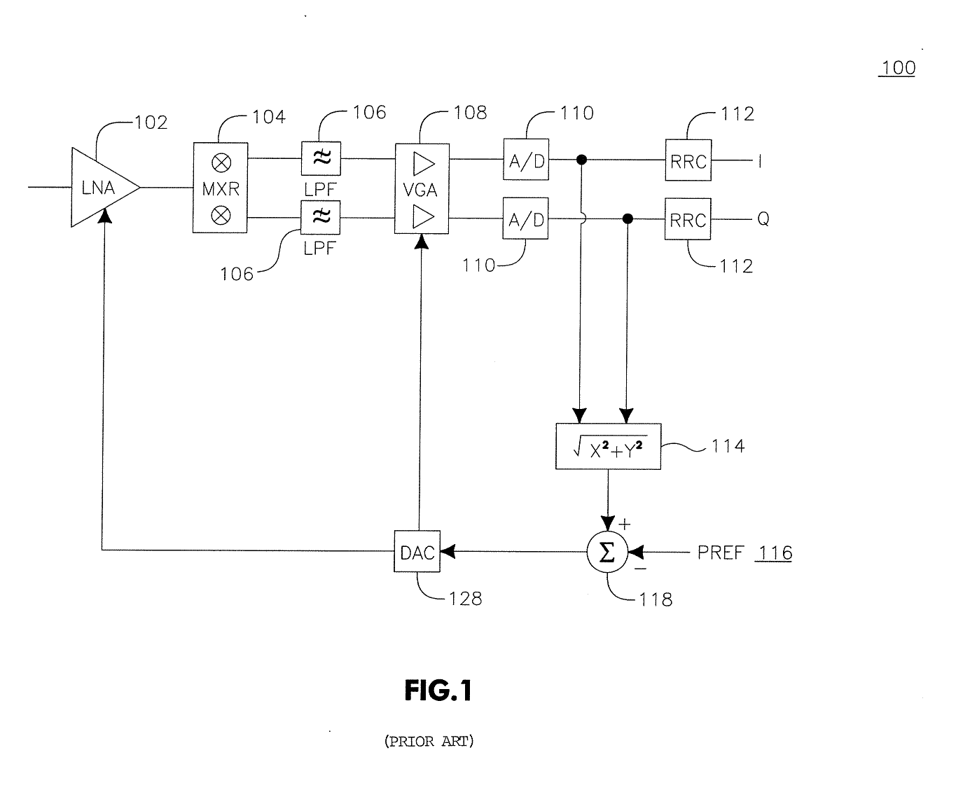

FIG. 2 is a schematic diagram of a RSSI-based AGC as in the prior art;

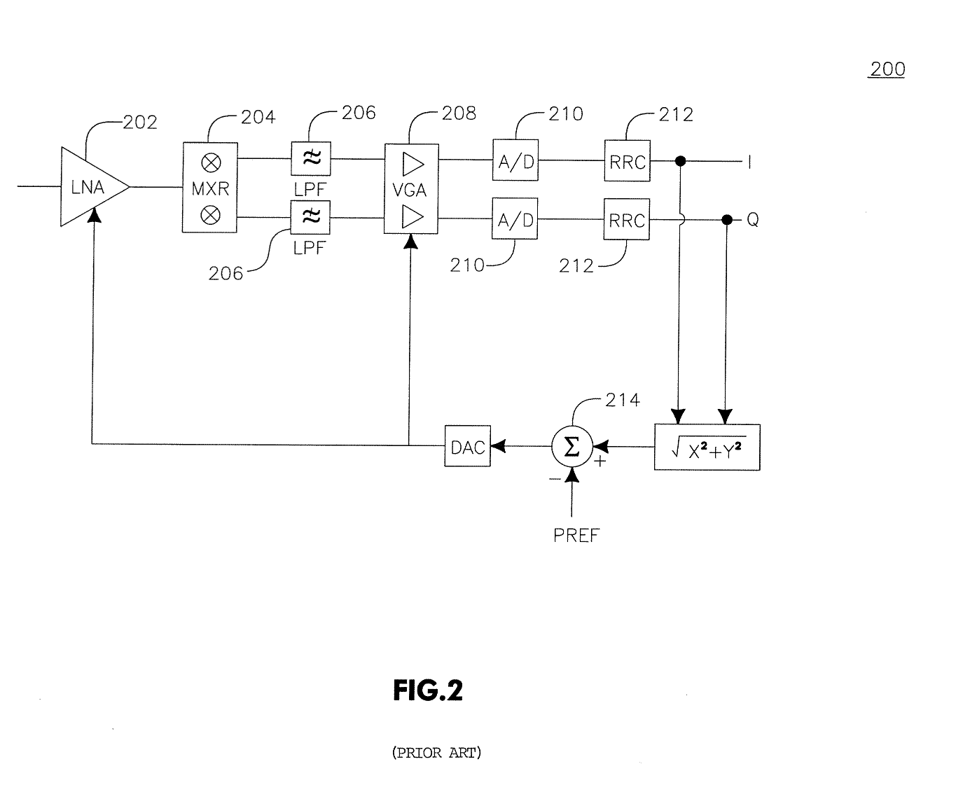

FIG. 3 is a graph of reference graph for P_{REF} (WRSSI) and P_{REF} (RSSI) as in the prior art;

FIG. 4 is a schematic diagram of an AGC circuit in accordance with one embodiment;

FIG. 5 is a schematic diagram of an AGC circuit in accordance with an alternative embodiment;

FIG. 6 is a schematic diagram of a composite WRSSI measure calculator in accordance with one embodiment;

FIG. 7 is a schematic diagram of an AGC employing sigma delta ADC in accordance with another embodiment;

FIG. 8 is a schematic diagram of a composite WRSSI measure calculator in accordance with the other embodiment; and

FIG. 9 is a graph of rms noise level in an adjacent channel in an example sigma delta ADC.

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

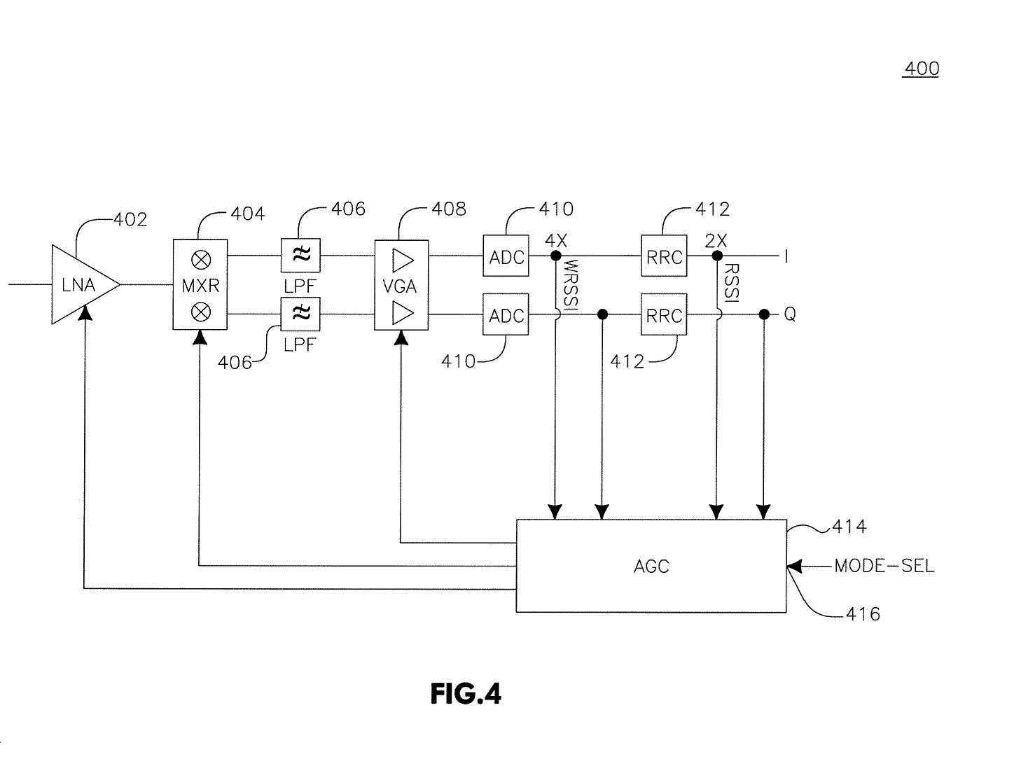

FIG. 4 is a schematic diagram of an AGC circuit 400 in accordance with one embodiment. AGC 400 may be part of a WTRU. A received analog signal is input into LNA 402. After amplification, the analog signal is processed by mixer 404, where the signal is split into the in-phase, I(t) and quadrature-phase, Q(t) components. I(t) and Q(t) are then filtered by LPFs 406 to remove any high frequency contents. Each signal is then amplified by VGA 408 and sent to ADCs 410 for processing. Typically, ADCs 410 run at a rate equal to four times a radio-frequency (RF) signal bandwidth. A typical RF signal bandwidth for a Universal Mobile Telephone System (UMTS) with Wideband Code Division Multiple Access (WCDMA) Frequency Division Duplex (FDD) signal is 3.84 MHz. A 4× clock rate equals 15.36 MHz. The folding frequency in this example is 7.68 MHz. The adjacent channel falls between 2.5 MHz and 7.5 MHz. Therefore, only I(t), q(t) and the adjacent channel interferer are discernable after sampling.

The processed signals are tapped and input into AGC block 412. After the WRRSI signal is RRC filtered in channel filter 414, the signal is tapped again as input to AGC block 414.

AGC block 414 may include at least one mixing circuit (not shown) to combine the WRSSI and RSSI and a comparator (not shown) to compare the combined signal with a reference signal. The output of the comparator may be input to a (DAC) (not shown). The output of the DAC may be used as a bias for the LNA 402, Mixer 404 and the VGA 408.

The WRSSI measure reflects the combined strength of the desired signal and the adjacent channel interferer. Sufficient analog filtering should be provided to suppress the in-band interferers in the different alternate channels. The RSSI measure reflects the strength of the desired signal only. AGC block 412 may function using the WRSSI signal only, the RSSI signal only, or a combination of the two signals. The function may be selected by mode select (mod_sel) switch 416 on AGC block 412.

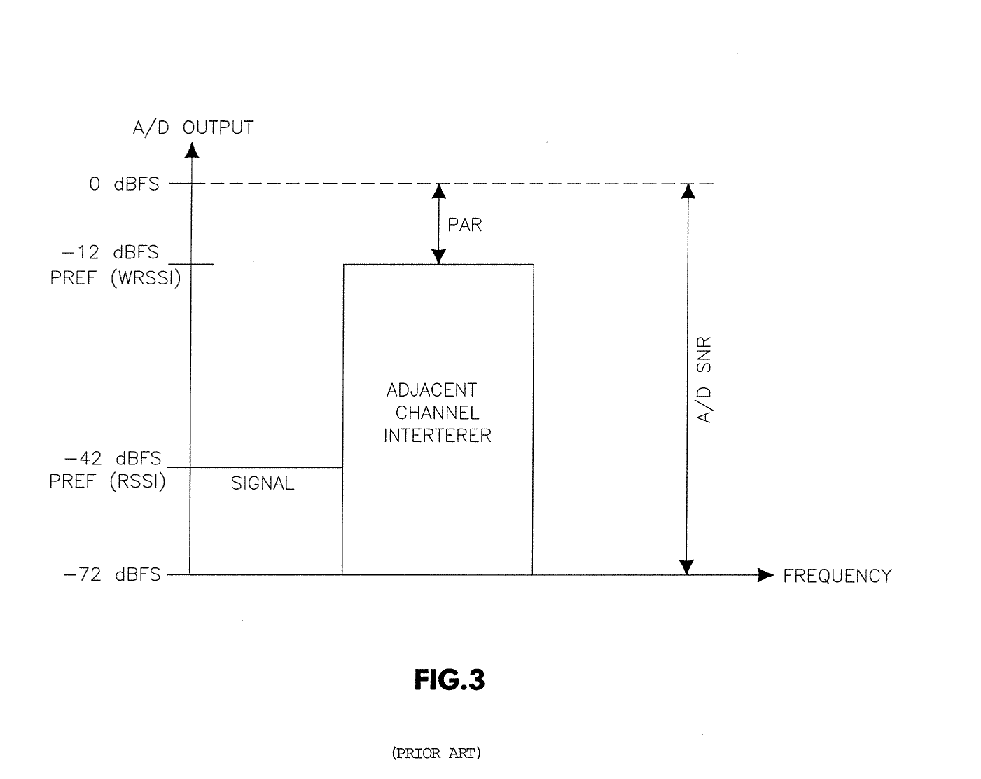

AGC 400 utilizes knowledge of both the adjacent channel interferer strength and the desired signal strength to set the receiver gain. This allows for design flexibility. By way of example, AGC 400 may be optimized to deliver maximum signal fidelity based only on the interferer level. Referring to FIG. 3, AGC reference power level, P_{REF} (WRSSI) may be set 12 dB below the full scale input for ADCs 410. In this case, AGC block 412 will generate a bias current that increase receiver gain, thereby delivering additional signal fidelity as the interferer level drops.

Alternatively, if additional signal fidelity is not required, the receiver gain may be kept constant as the interferer level drops by reducing the AGC reference power level, P_{REF}(WRSSI). Furthermore, in addition to maintaining a constant receiver gain with decreasing interferer levels, the receiver's second order intercept point (IP2) and third order intercept point (IP3) may be reduced by decreasing the bias current sent to the receiver front-end analog components.

AGC 400 may also be configured to minimize receiver power consumption based only on the desired signal strength. Referring again to FIG. 3, AGC reference power, P_{REF}(RSSI) would be set 42 dB below the full scale input of ADCs 410. In this case AGC block 412 may generate a bias current to force the receiver gain to decrease with increasing signal strength. If the signal strength exceeds certain predefined levels, sections of the receiver analog front-end may be turned off, thereby reducing power consumption.

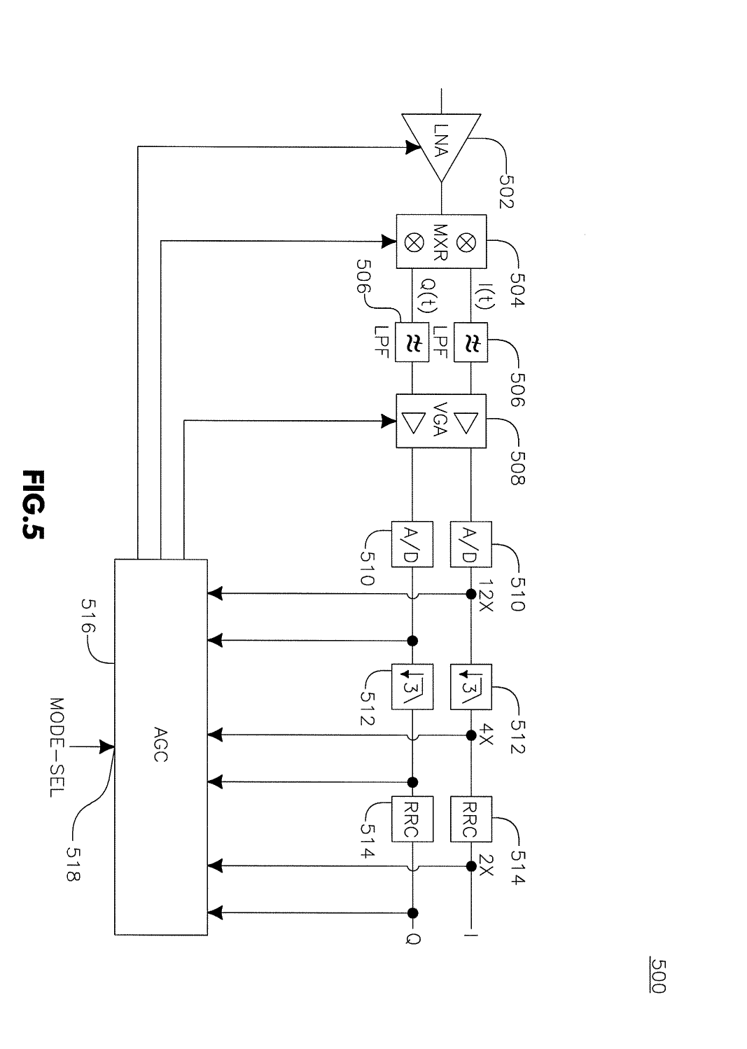

FIG. 5 is a schematic diagram of an AGC 500 in accordance with an alternative embodiment. Similar to the AGC 400 of FIG. 4, the received analog signal is input into LNA 502. After amplification, the analog signal is processed by mixer 504, where the signal is split into its I(t) and Q(t) components. Both I(t) and Q(t) are filtered by LFPs 506 to remove high frequency components. Each signal is then amplified by VGA 508 and sent to ADCs 510 for processing. ADCs 510 run at a rate equal to twelve times the RF signal bandwidth. The RF signal bandwidth for a UMTS WCDMA FDD signal is typically 3.84 MHz and a 12× clock rate equals 46.08 MHz. The folding frequency in this case is 23.04 MHz. The adjacent channel falls between 2.5 MHz to 7.5 MHz. The first, second and third alternate channels fall between 7.5 MHz to 12.5 MHz, 12.5 MHz to 17.5 MHz and 17.5 MHz to 22.5 MHz. Therefore, the signal, the adjacent channel interferer, the first, second and third alternate channel interferers are all discernable after sampling.

The signals are tapped before filtering to create WRSSI_1. The WRSSI_1 measure reflects the combined strength of the signal, the adjacent channel interferer and the three subsequent alternate channel interferers. The signals are tapped after processing by decimation filter 512 to create WRSSI_0. The WRSSI_0 measure reflects the combined strength of the desired signal and the adjacent channel interferer. Lastly, the signals are filter through RRC filter 514 to create the RSSI. WRRSI_0, WRSSI_1 and RSSI are input into AGC block 516 and may be used independently or together to create a bias current for LNA 502, mixer 504 and VGA 508. Mode_sel switch 518 may be used to switch between any or all of the RSSI and WRRSI signals.

Increased sampling frequency may be used when sufficient analog selectivity is not available to suppress all the alternate channel interferers. A measure of the combined strength of the different interferers may be derived by taking a weighted sum of the WRSSI_0 and the WRSSI_1 measures depending on the analog selectivity available in the respective adjacent and alternate channels. The weighted sum would be treated as the WRSSI measure.

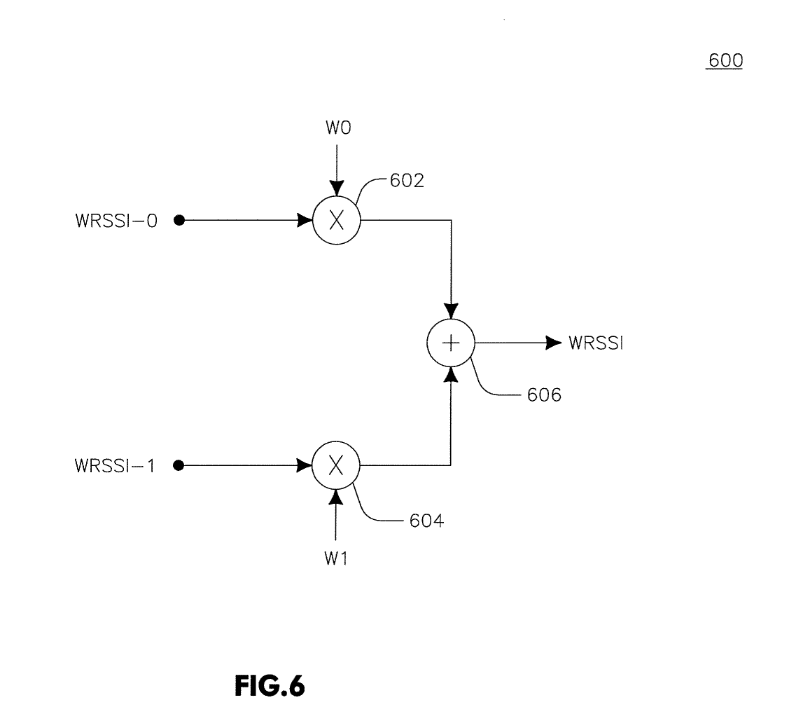

FIG. 6 is a partial schematic diagram of a composite WRSSI measure calculator 600 in accordance with an alternative embodiment. WRSSI_0 is weighted by WO at multiplier 602. WRSSI_1 is weighted by WI at multiplier 604. The weighted signals are combined at mixer 606 to create the WRSSI measure.

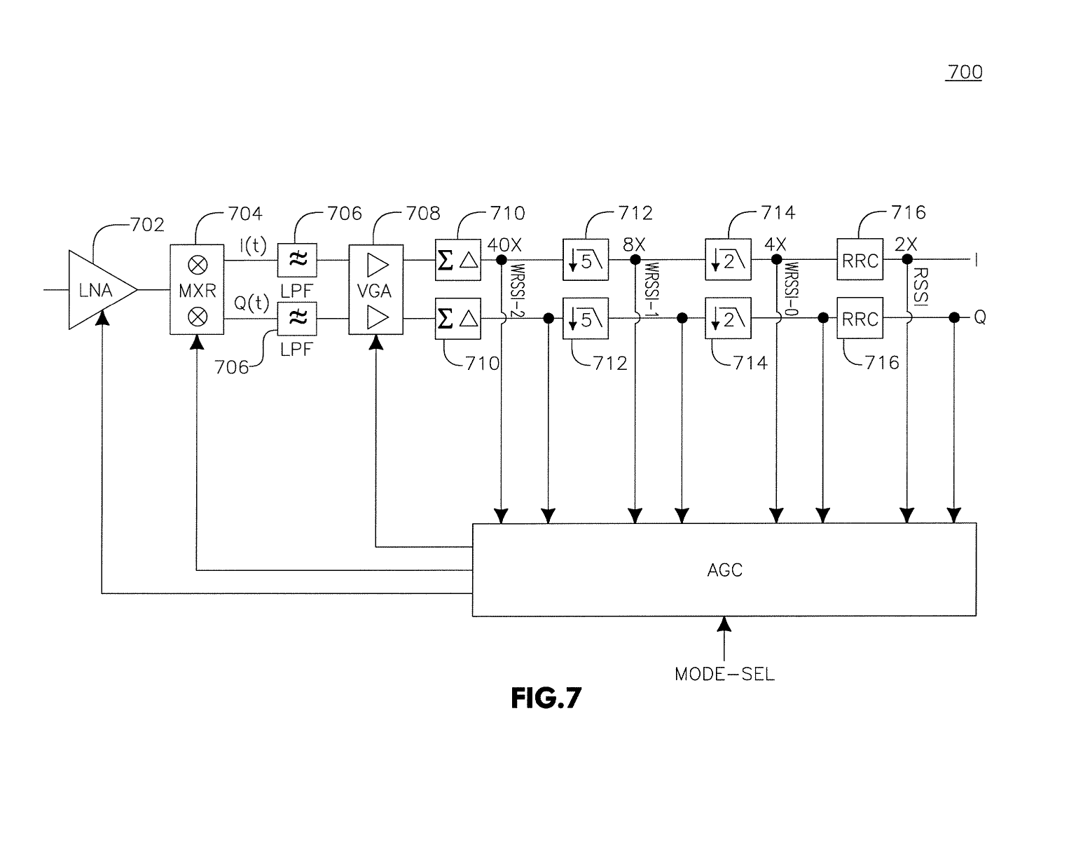

FIG. 7 is a schematic diagram of an AGC system 700 employing sigma delta ADCs, in accordance with another embodiment. AGC system 700 functions similarly to AGC 400 and AGC 500, with the exception that the WRSSI measurements for AGC 700 include not only the desired signal and the interference signals, but also the noise from the sigma delta ADCs 710. The example sigma delta ADC is shown to run at 40× over sampling rate. As shown in FIG. 7, the signal is tapped before filtering, and is tapped again after each of several filters 712, 714, 716. This creates several different WRSSI measurements (WRSSI_2, WRSSI_1, WRSSI_0).

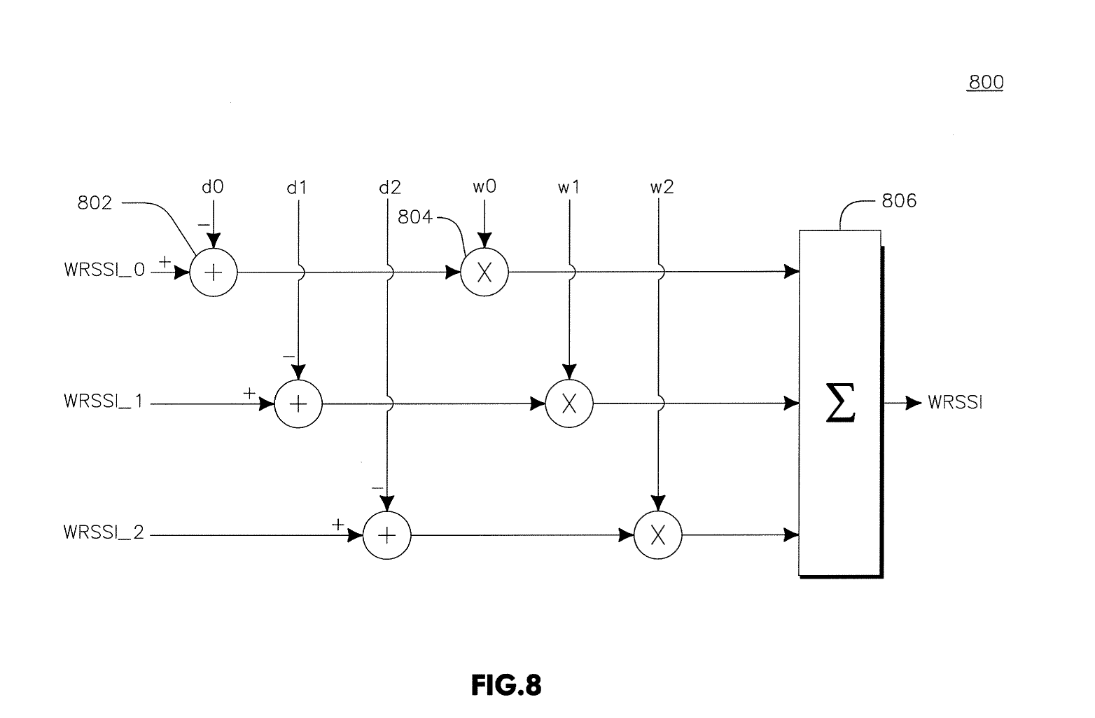

FIG. 8 is a partial schematic diagram of a composite WRSSI measure calculator 800, in accordance with the alternative embodiment. A different constant must be subtracted from the different WRSSI measurements before forming the weighted sum due to the noise of the sigma delta ADCs 710. The constants may be derived based on the sigma delta ADC noise properties. The weighted sum may be treated as the WRSSI measure.

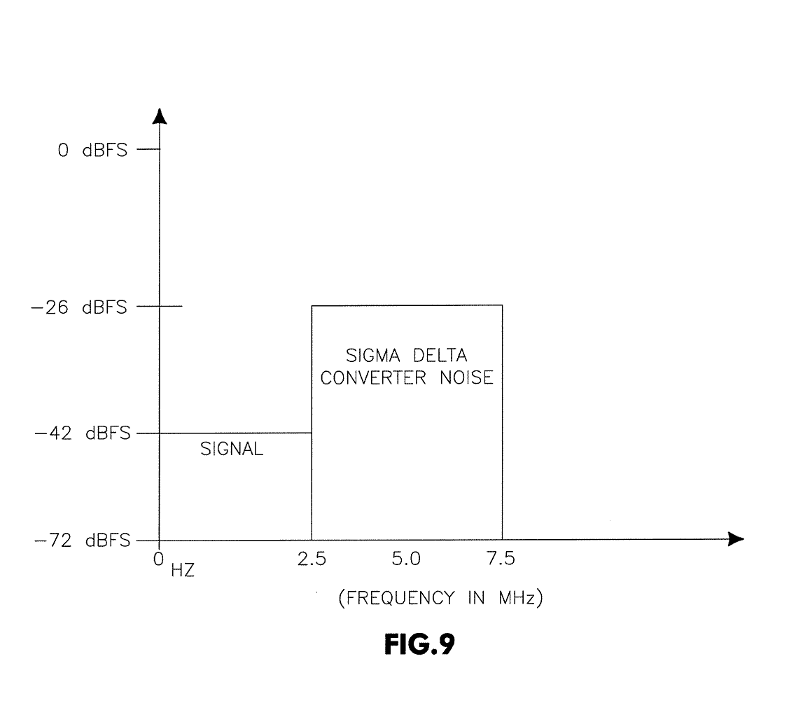

FIG. 9 is a graph of the example sigma delta ADCs 710 rms noise level in an adjacent channel. In particular, the frequency response of a typical 1-bit sigma delta ADC employed in a typical UMTS WCDMA FDD receiver is shown. A sigma delta ADC typically runs at 40× or 153.6 MHz. The folding frequency in this case is 76.8 MHz. The integrated power of the pushed sigma delta noise in the adjacent channel is shown to be 26 dB below the ADCs full scale input. Higher levels of pushed noise exist in the different alternate channels. It is known that the total power of a typical 1-bit sigma delta ADC output splits between the signal power and the total integrated noise power. At maximum signal output (−3 dBFS), the sigma delta ADC output splits equally between the signal and the noise. As the signal level increases, the noise level decreases. However, since the noise is spread out over a large band of frequencies, any change in noise level within a 5 MHz band for every dB of signal power change is small.

The pushed noise in the adjacent and each of the subsequent alternate channels remains relatively constant over the input range of the ADC. In other words, the receiver gain does not significantly influence the pushed sigma delta noise in the adjacent channel or each of the alternate channels. This pushed sigma delta noise appears as interferers to the AGC 700. Changes in the receiver gain do not influence the level of this type of interferer.

Although the features and elements are described in the embodiments in particular combinations, each feature or element can be used alone without the other features and elements of the preferred embodiments or in various combinations with or without other features and elements. The methods or flow charts provided may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A wireless transmit receive unit (WTRU) comprising a receiver and an automatic gain circuit (AGC), the AGC comprising:
a circuit for acquiring a desired signal strength;
a circuit for acquiring an interferer strength; and
a circuit for setting a gain of the receiver based upon the desired signal strength and the interferer strength.

2. The WTRU as in claim 1 wherein the interferer strength is an adjacent channel interferer strength.

3. The WTRU as in claim 1 wherein the AGC further comprises a circuit for measuring a wideband received signal strength indicator (WRSSI), and a received signal strength indicator (RSSI).

4. The WTRU as in claim 3 wherein the AGC further comprises a circuit for generating a bias based on the WRSSI and the RSSI.

5. The WTRU as in claim 3 wherein the AGC further comprises a circuit for generating a bias based on the WRSSI or the RSSI.

6. The WTRU as in claim 3 wherein the AGC further comprises a circuit for selecting between the WRSSI and the RSSI.

7. The WTRU as in claim 3 wherein the AGC further comprises a circuit for weighting the WRRSI and the RSSI.

8. The WTRU as in claim 7 wherein the AGC further comprises a circuit for combining the weighted WRSSI and the weighted RSSI to create a true WRSSI, comparing the true WRSSI to a power reference, and creating a bias signal based on a difference between the true WRSSI and the power reference.

9. The WTRU as in claim 1 wherein the AGC further comprises a circuit for to maximizing signal fidelity based only on the interferer strength.

10. The WTRU as in claim 1 wherein the AGC further comprises a circuit for minimizing receiver power consumption is based only on the desired signal strength.

11. The WTRU as in claim 1 wherein the AGC further comprises a circuit for detecting the desired signal and a plurality of alternate channel interferers after sampling.

12. The WTRU as in claim 10 wherein the AGC further comprises a circuit for weighting the desired signal and weight the plurality of alternate channel interferers.

13. The WTRU as in claim 12 wherein the AGC further comprises a circuit for combining the weighted desired signal and the weighted plurality of alternate channel interferers.

14. The WTRU as in claim 13 wherein the AGC further comprises a circuit for comparing the combined weighted desired signal and the weighted plurality of alternate channel interferers with a power reference to create a difference signal and creating a bias signal based on the difference signal.

15. The WTRU as in claim 1 wherein the AGC further comprises a circuit for increasing the receiver gain as the interferer strength drops.

16. The WTRU as in claim 1 wherein the WTRU further comprises a circuit for reducing a power reference to maintain the receiver gain at a constant.

17. The WTRU as in claim 1 wherein the AGC further comprises a circuit for turning off a section of the receiver based on a measurement of the desired signal strength.

18. The WTRU as in claim 1 wherein the AGC comprises a sigma delta analog to digital converter in a receiver.

19. An automatic gain control (AGC) circuit comprising:
a desired signal input;
an interferer signal input;
a power reference input;
a mixer for combining the desired signal input and the interferer signal input to create a combined signal; and
a comparator for comparing the combined signal and the power reference input to create a bias signal.

20. The WTRU as in claim 19 further comprising a plurality of interferer inputs.

21. The WTRU as in claim 19 further comprising a mode select switch for selecting inputs.

22. A method of automatic gain control (AGC) in a wireless transmit receive unit (WTRU) comprising:
acquiring a desired signal strength;
acquiring an interferer strength; and
setting a gain of a receiver based on the desired signal strength and the interferer strength.

23. The method of claim 22 further comprising:
combining the desired signal strength and the interferer strength;
comparing the combined desired signal strength and interferer strength with a power reference; and
generating a bias signal based on the comparison.

24. The method of claim 22 further comprising selecting from the desired signal strength and a plurality of interferer strengths.

25. A wireless transmit receive unit (WTRU) comprising an integrated circuit (IC), the IC configured to:
acquire a desired signal strength;
acquire an interferer strength; and
set a gain of a receiver based on the desired signal strength and interferer strength.
